(19) United States
(12) Patent Application Publication
(10) Pub. No.: US 2025/0353799 A1
(43) Pub. Date: Nov. 20, 2025

(54) SOIL AMENDMENT FOR REGULATING SALINITY AND ALKALINITY AND SOLIDIFYING HEAVY METALS, PREPARATION AND APPLICATION THEREOF

(71) Applicant: Xinjiang Institute of Ecology and Geography, Chinese Academy of Sciences, Urumqi (CN)

(72) Inventors: Liang Pei, Urumqi (CN); Fan Yang, Urumqi (CN); Wufuer Rehemanjiang, Urumqi (CN); Jia Duo, Urumqi (CN); Zhengzhong Jin, Urumqi (CN); Shuzhi Wang, Urumqi (CN); Wenfeng Li, Urumqi (CN)

(21) Appl. No.: 19/207,425

(22) Filed: May 14, 2025

(30) Foreign Application Priority Data
May 14, 2024 (CN) 2024105969246

(51) Int. Cl. C05G 3/80; C09K 17/06; C09K 17/10; C09K 17/32

(52) U.S. Cl. CPC C05G 3/80; C09K 17/06; C09K 17/10; C09K 17/32

(57) ABSTRACT

A soil amendment for regulating salinity and solidifying heavy metals includes 50-70 parts by weight of natural calcium-based bentonite, 20-25 parts by weight of fly ash, 10-20 parts by weight of water, 20-25 parts by weight of weathered coal, and 2-6 parts by weight of composite microbial agent. The soil amendment not only efficiently removes pollutants from poor-quality soil, but also increases the yield and quality of plants. It can also provide a new idea for expanding the application research of the natural calcium-based bentonite, the fly ash, the weathered coal, and salt and drought-resistant plants to more fields. This degradation of the soil amendment has high efficiency, low cost, easy operation, and does not cause secondary pollution, and has broad application prospects.

### CROSS-REFERENCE TO RELATED APPLICATION

This application claims priority to Chinese patent application No. CN 202410596924.6, filed to China National Intellectual Property Administration (CNIPA) on May 14, 2024, which is herein incorporated by reference in its entirety.

### TECHNICAL FIELD

The disclosure relates to the technical field of industrial solid waste treatment and comprehensive utilization, and particularly to a soil amendment for regulating salinity and alkalinity and solidifying heavy metals, a preparation method and an application method thereof.

### BACKGROUND

Inferior soil is categorized into saline-alkali soil, sandy soil, and contaminated soil. Soil amendments are one of the important methods for remediating the inferior soil. Naturally occurring bentonite deposits in nature are generally divided into natural calcium-based bentonite and natural sodium-based bentonite. Tests have shown that the natural calcium-based bentonite is weakly acidic with a potential of hydrogen (pH) of 6-7, while the natural sodium-based bentonite is slightly alkaline with a pH of 8. The bentonite available for purchase is mostly in powder form, such as natural calcium-based bentonite, artificially modified sodium-based bentonite, or activated bleaching earth. Natural bentonite is rarely found and is a very scarce resource.

The pH of artificially modified calcium-based bentonite can be artificially adjusted. The pH of calcium-based bentonite can be increased from 6 to around 7, thereby meeting specifications for drilling fluid mud materials or fulfilling requirements for other chemical applications. This product is free from any chemical additives and is relatively safe and environmentally friendly. It is commonly used for preparation of feed additives, food additives, fillers for rubber and plastics, fertilizer binders, fillers, water quality improvers, adsorbents, bactericides, carriers for pesticides, and activated carbon.

A certain autonomous region has a large stockpile of coal-based solid waste that is difficult to dispose of, such as weathered coal and fly ash, which are the most abundant. At the same time, to the region also has heavy metal soil pollution. Moreover, the region has the largest area and the most alkalinity saline-alkali soil, as well as sandy soil and contaminated soil need to be remediated. It is necessary to adopt a waste-to-waste approach and a site-specific strategy to address the above issues.

The industry has conducted extensive research on the remediation and disposal technologies for saline-alkali soil, sandy soil, and coal-based solid waste. However, the main methods still involve addition of amendments, resource recovery, and natural restoration. These methods face a series of problems, such as high costs, unpredictable potential risks, and long recovery periods that lead to persistent environmental hazards. It is of great practical significance and ecological benefits to conduct research on screening of saline-alkali tolerant plants and soil amendments, as well as combination of the plants and the soil amendments to remediate inferior soil (saline-alkali soil and sandy soil) and coal-based solid waste stockpiles aiming for the problems of high salinity and alkalinity, low water capacity, and lack of organic matter in saline-alkali soil and sandy soil.

In some areas, a large amount of the fly ash and the weathered coal cannot be disposed of or utilized, resulting in significant waste and secondary pollution. In recent years, attempts have been made to remediate saline-alkali soil or sandy soil using acidic calcium-based bentonite, coal-based solid waste, or a combined composite method thereof. The acidic calcium-based bentonite and the fly ash have a large specific surface area and are relatively loose, which can be used to improve alkaline soil. The weathered coal itself is humic acid, which is a breeding ground for microbial proliferation and development. The mixture of coal-based solid waste after biochemical treatment can reduce the alkalinity of saline-alkali soil, improve soil structure, and enhance aeration and permeability. When combined with the weathered coal and saline-alkali tolerant and drought tolerant plants, it can effectively improve sandy or saline-alkali soil.

The humic acid is a type of organic material formed and accumulated through the decomposition and transformation of food waste or animal and plant remains (mainly plant remains, such as straw) by microorganisms, as well as a series of geochemical processes. The humic acid is present in large quantities, amounting to trillions of tons. It can be found in rivers, lakes, seas, coal mines, and most surface areas of the Earth. Due to its widespread presence, it has a significant impact on the Earth, involving aspects such as the carbon cycle, mineral migration and accumulation, soil fertility, and ecological balance. The most promising resources for the development and utilization of the humic acid are low-calorific coals, such as peat, lignite, and the weathered coal. Among them, the humic acid content can reach 10%-80%. China has a very rich coal reserve. According to available data, there are 5 billion tons of peat, 126.5 billion tons of lignite, and no statistical data on the weathered coal yet. The production and application of the humic acid can also be considered as a part of coal chemical industry. A basic structure of the humic acid macromolecules consists of aromatic and aliphatic rings, with functional groups such as carboxyl, hydroxyl, carbonyl, quinone, and methoxy groups attached to the rings, which are conducive to the degradation of various pollutants and the balancing of soil acidity and alkalinity. In the field of bioengineering, further screening of superior strains, accelerated development of targeted strains, and research and development of biochemical humic acid or biochemical fulvic acid products are also beneficial for development.

### SUMMARY

To overcome the problems in related technologies, the disclosed embodiments of the disclosure provide a soil amendment for salinity and alkalinity and solidifying heavy metals, a preparation method, and application thereof. The purpose of the disclosure is to treat various types of inferior soil by adapting to local conditions and using waste treatment methods.

The technical solutions of the disclosure are as follows.

A soil amendment for regulating salinity and alkalinity and solidifying heavy metals includes 50-70 parts by weight of natural calcium-based bentonite, 20-25 parts by weight of fly ash, 10-20 parts by weight of water, 20-25 parts by weight of weathered coal, and 2-6 parts by weight of composite microbial agent.

A preparation method is used to prepare the soil amendment for regulating salinity and alkalinity and solidifying heavy metals, and the preparation method includes steps: S1: modifying the natural calcium-based bentonite, S2: preparing a composite microbial agent, S3: preparing humic acid from the weathered coal, and S4: preparing the soil amendment for regulating salinity and alkalinity and solidifying heavy metals.

In the S1, the modifying natural calcium-based bentonite includes steps as follows. auxiliary materials are dissolved in the water, then the water dissolved with the auxiliary materials is evenly sprayed onto a surface of the calcium-based bentonite. a water content of the calcium-based bentonite is in a range of 20%-30%; and raw materials, by mass, include: 40%-60% of the calcium-based bentonite, and 10%-15% of food waste, distiller's grains, and straw powder, and the auxiliary materials, by mass, comprise: 1%-2% of urea, and 1%-3% of calcium chloride. Heavy metal solidifying bacteria Bacillus asahii with an addictive amount of 0.1%-0.3% is added to solidify residual heavy metals in the calcium-based bentonite. The soil amendment includes 50-70 parts by weight of natural calcium-based bentonite, 20-25 parts by weight of fly ash, 10-20 parts by weight of water, 20-25 parts by weight of weathered coal, and 2-6 parts by weight of composite microbial agent. Food waste, distiller's grains, and straw powder are used in the modification of the natural calcium-based bentonite and are the preparation of humic acid.

In the S2, the preparing a composite microbial agent includes steps as follows. Azotobacter sp., Pseudomonas chlororaphis strain R5, Bacillus subtilis, and Pseudomonas putida strain Rs-198 are mixed with a mixing ratio in a range of 1-2:2-2.5:2-2.5:3-5.

In the S3, the preparing humic acid from the weathered coal includes steps S301-S305 as follows.

S301: The weathered coal, food waste, livestock and poultry manure, and straw powder are mixed with the composite microbial agent to obtained a mixed material, thereby performing aerobic fermentation on the mixed material for humification in a fermentation tank by using a film-covered method. Humidity of the mixed material is in a range of 15% to 20%, a stacking height of the mixed material is in a range of 100 centimeters (cm) to 120 cm, an aeration rate is in a range of 2 cubic meters per second (m³/s) to 6 m³/s, and a duration of the aerobic fermentation is in a range of 10 days to 20 days. The mixed material is dehydrated to 20% to 22%, and followed by crushing and sieving with a 1 millimeter (mm) sieve to prepare a saline-alkali planting improved substrate. The mixing the weathered coal, food waste, livestock and poultry manure, and straw powder with the composite microbial agent to obtained a mixed material specifically includes steps as follows. 1 ton (t) of the food waste, the livestock and poultry manure, and the straw powder are mixed with 2.0 kilograms (kg) to 2.5 kg of the composite microbial agent. A comprehensive moisture content of the food waste, the livestock and poultry manure, and the straw powder is in a range of 20% to 22%.

S302: The mixed material is piled into the fermentation tank, and a first stage of the aerobic fermentation is performed on the mixed material under positive pressure with a film cover to obtain a mixed material after the first stage of the aerobic fermentation. A duration of the first stage of the aerobic fermentation is in a range of 10 days to 13 days, and a moisture content of the mixed material after the first stage of the aerobic fermentation is 20% to 30%.

S303: The mixed material undergone the first stage of the aerobic fermentation is uncovered and turned after the first stage of the aerobic fermentation to obtain an uncovered and turned mixed material.

S304: A second stage of the aerobic fermentation without film coverage is performed on the uncovered and turned mixed material to obtain a fermented mixed material. The second stage of the aerobic fermentation is performed in a ventilated workshop with a roof, a loader is used to transport the mixed material to the ventilated workshop, and the mixed material is turned during transport.

S305: After completing the aerobic fermentation to obtain the humic acid, a part of the fermented mixed material is used as a return material for the mixing in the S301.

In the S302, after piling the mixed material into the fermentation tank, the stacking height of the mixed material is higher than a height of the fermentation tank, and the stacking height of the mixed material is 100 cm to 120 cm.

Specifically, a bottom of the fermentation tank defines three air supply channels, and a 2.2 kilowatts (kW) fan is used for ventilation for 8 hours to 9 hours per day. The film cover is punched with holes, temperature sensors are disposed on the holes to monitor fermentation temperature in real-time, and a number of the temperature sensors is equal to a number of days in the first stage of the aerobic fermentation. The film cover is fixed with weights during a film-covering process of the first stage of the aerobic fermentation.

In the S302, the film cover is a composite membrane with an expanded polytetrafluoroethylene (ePTFE) membrane in a middle and polyester membranes on two sides; and micropores with a bore diameter of 0.2 microns (μm) are defined evenly on the ePTFE membrane.

In the S304, a duration of the second stage of the aerobic fermentation is in a range of 8 days to 13 days, and the moisture content of the mixed material after the first stage of the aerobic fermentation is in a range of 20% to 30%.

In the S4, the preparing the soil amendment for regulating salinity and alkalinity and solidifying heavy metals includes steps as follows. The natural calcium-based bentonite, the fly ash, the humic acid, and the weathered coal naturally are stacked for 6 days to 7 days to obtain the soil amendment for regulating salinity and alkalinity and solidifying heavy metals. A pH of the calcium-based bentonite is in a range of 6.5 to 7.2, a pH of the fly ash is in a range of 8.5 to 9.8, a ratio of the natural calcium-based bentonite and the fly ash is in a range of 2-3:1, and a ratio of the natural calcium-based bentonite:the fly ash:the weathered coal is in a range of 2-3:1:1.

The disclosure further provides an application method of the soil amendment for regulating the salinity and alkalinity and solidifying the heavy metals in remediation of inferior soil with the natural calcium-based bentonite and coal-based solid waste. The inferior soil is remediated by using the soil amendment for regulating salinity and alkalinity and solidifying heavy metals mentioned above.

Combining all the above technical solutions, the beneficial effects of the disclosure are as follows.

The disclosure creates a soil amendment and preparation method thereof to regulate salinity and alkalinity and solidifying heavy metals. The soil amendment is made by mixing and fermenting the natural calcium-based bentonite (PRT), the fly ash (FMH), and the weathered coal (FHM) for improving the saline-alkali soil and sandy soil. Moreover, when compared with a use of the modified FMH or the FHM alone, the PRT-FMH combination has been found to be 12% more efficient in removing salinity and alkalinity and 9% more efficient in removing pollution than using the modified FMH and the FHM alone, respectively. Additionally, it is highly effective when used in conjunction with the planting of salt and drought-resistant plants (such as Elaeagnus angustifolia and Hippophae rhamnoides). The method not only efficiently removes pollutants from inferior soil, but also increases the yield and quality of plants. It also proposes a new approach for expanding the application research of natural calcium-based bentonite, fly ash, weathered coal, and saline-alkali tolerant and drought tolerant plants into more fields. The disclosure has high degradation efficiency, low cost, easy operation, and no secondary pollution, which offers broad prospects for application.

### BRIEF DESCRIPTION OF DRAWINGS

The attached drawings are incorporated into the specification and form a part of the specification, illustrating embodiments in accordance with the disclosure and used together with the specification to explain the principles of the disclosure.

FIG. 1 illustrates a flowchart of a preparation method for a soil amendment for regulating salinity and alkalinity and solidifying heavy metals in an embodiment of the disclosure.

FIG. 2 illustrates a schematic structural diagram of a fermentation tank, a film cover, and temperature sensors in the embodiment of the disclosure.

FIG. 3 illustrates a flowchart of a preparation of humic acid from weathered coal provided in the embodiment of the disclosure.

### DETAILED DESCRIPTION OF EMBODIMENTS

In order to make the above objectives, features, and advantages of the disclosure more obvious and understandable, the specific embodiments of the disclosure will be described in detail below in conjunction with the attached drawings. Many specific details are elaborated in the following description to facilitate a thorough understanding of the disclosure. However, the disclosure can be implemented in many different ways than described herein, and those skilled in the art can make similar improvements without departing from the scope of the disclosure. Therefore, the disclosure is not limited by the specific embodiments disclosed below.

The innovative aspects of the disclosure are as follows. The disclosure uses natural calcium-based bentonite as a substitute for the commonly used sodium-based bentonite as a raw material for soil amendment, thereby expanding the application scope of natural calcium-based bentonite. The disclosure makes full use of the potential value of coal-based solid waste and agricultural and pastoral solid waste, enhancing their economic value. It combines the natural calcium-based bentonite, the fly ash, the weathered coal, agricultural and pastoral solid waste, and microbial agent to leverage their respective advantages and amplify these benefits through the synergistic effects between the various raw materials. The preparation process is simple and easy to operate, with minimal equipment requirements, giving it an inherent advantage for large-scale promotion and application.

### Embodiment 1

The disclosure provides a preparation method for a soil amendment for regulating salinity and alkalinity and solidifying heavy metals, which is made by uniformly mixing natural calcium-based bentonite (PRT), fly ash (FMH), and weathered coal (FHM). The objective of the disclosure is to provide a method that can adjust the physical and chemical properties of saline-alkali soils and sandy soils, as well as solidify heavy metal pollutants, with the aim of reducing the amount of improver used and enhancing the improvement effects on inferior soils.

As shown in FIG. 1, a preparation method for the soil amendment for regulating salinity and alkalinity and solidifying the heavy metals includes S1 to S5 as follows.

S1: the natural calcium-based bentonite is modified.

The specific improvement measures for the modified preparation of the natural calcium-based bentonite are as follows. Auxiliary materials are dissolved in the water, then the water dissolved with the auxiliary materials is evenly sprayed onto a surface of the calcium-based bentonite. a water content of the calcium-based bentonite is in a range of 20%-30%; and raw materials, by mass, include: 40%-60% of the calcium-based bentonite, and 10%-15% of food waste, distiller's grains, and straw powder, and the auxiliary materials, by mass, comprise: 1%-2% of urea, and 1%-3% of calcium chloride. Heavy metal solidifying bacteria Bacillus asahii with an addictive amount of 0.1%-0.3% is added to solidify residual heavy metals in the calcium-based bentonite.

S2: a composite microbial agent from is prepared.

The microbial agent (composite microorganisms) is purchased from Bao Sai Biotech Company. The microbial agent includes Azotobacter sp., Pseudomonas chlororaphis strain R5, Bacillus subtilis, and Pseudomonas putida strain Rs-198, and a mixing ratio is in a range of 1-2:2-2.5:2-2.5:3-5.

S3: humic acid is prepared from the weathered coal.

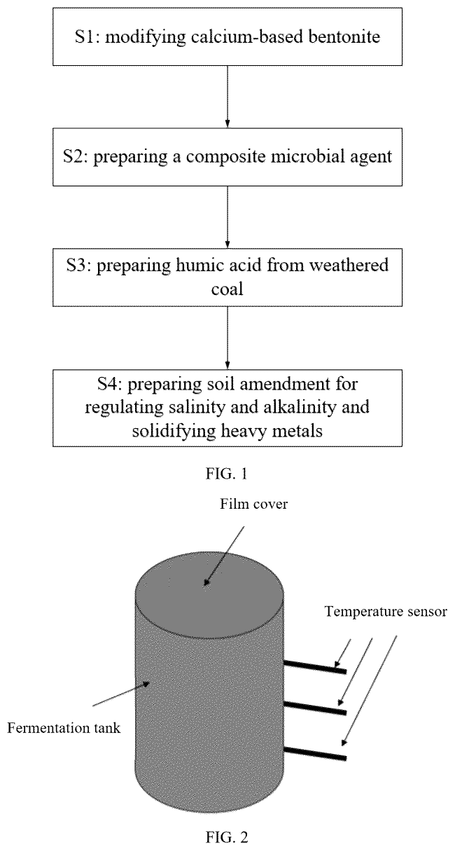

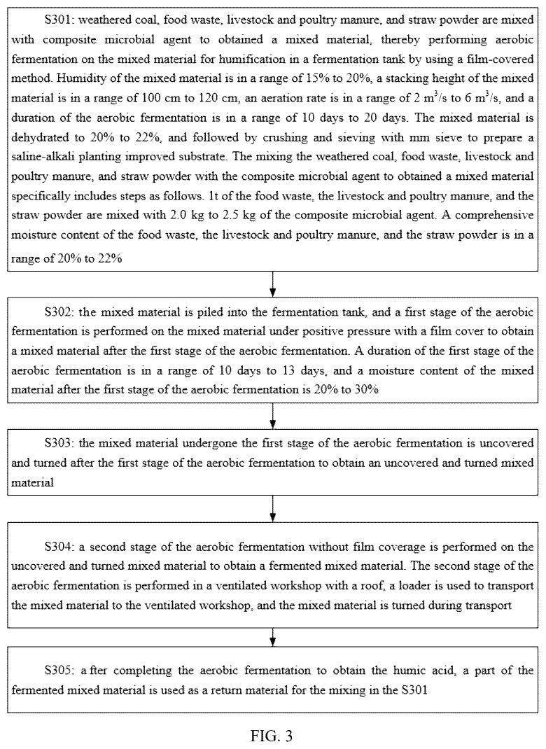

As shown in FIG. 2, the S3 includes S301-S305.

S301: The weathered coal, food waste, livestock and poultry manure, and straw powder are mixed with the composite microbial agent to obtained a mixed material, thereby performing aerobic fermentation on the mixed material for humification in a fermentation tank by using a film-covered method. Humidity of the mixed material is in a range of 15% to 20%, a stacking height of the mixed material is in a range of 100 centimeters (cm) to 120 cm, an aeration rate is in a range of 2 cubic meters per second (m³/s) to 6 m³/s, and a duration of the aerobic fermentation is in a range of 10 days to 20 days. The mixed material is dehydrated to 20% to 22%, and followed by crushing and sieving with a 1 millimeter (mm) sieve to prepare a saline-alkali planting improved substrate. The mixing the weathered coal, food waste, livestock and poultry manure, and straw powder with the composite microbial agent to obtained a mixed material specifically includes steps as follows. 1 ton (t) of the food waste, the livestock and poultry manure, and the straw powder are mixed with 2.0 kilograms (kg) to 2.5 kg of the composite microbial agent. A comprehensive moisture content of the food waste, the livestock and poultry manure, and the straw powder is in a range of 20% to 22%.

S302: The mixed material is piled into the fermentation tank, and a first stage of the aerobic fermentation is performed on the mixed material under positive pressure with a film cover to obtain a mixed material after the first stage of the aerobic fermentation. A duration of the first stage of the aerobic fermentation is in a range of 10 days to 13 days, and a moisture content of the mixed material after the first stage of the aerobic fermentation is 20% to 30%.

S303: The mixed material undergone the first stage of the aerobic fermentation is uncovered and turned after the first stage of the aerobic fermentation to obtain an uncovered and turned mixed material.

S304: A second stage of the aerobic fermentation without film coverage is performed on the uncovered and turned mixed material to obtain a fermented mixed material. The second stage of the aerobic fermentation is performed in a ventilated workshop with a roof, a loader is used to transport the mixed material to the ventilated workshop, and the mixed material is turned during transport.

S305: After completing the aerobic fermentation to obtain the humic acid, a part of the fermented mixed material is used as a return material for the mixing in the S301.

In an embodiment, the composite microbial agent is high-temperature resistant fermentation microorganisms, which can shorten the high-temperature fermentation cycle and reduce time and cost.

In an embodiment, in the S302, after piling the mixed material into the fermentation tank, the stacking height of the mixed material is higher than a height of the fermentation tank, and the stacking height of the mixed material is 100 cm to 120 cm.

Specifically, a bottom of the fermentation tank defines three air supply channels, and a 2.2 kilowatts (kW) fan is used for ventilation for 8 hours to 9 hours per day. The film cover is punched with holes, temperature sensors are disposed on the holes to monitor fermentation temperature in real-time, and a number of the temperature sensors is equal to a number of days in the first stage of the aerobic fermentation. The film cover is fixed with weights during a film-covering process of the first stage of the aerobic fermentation.

In the S302, the film cover is a composite membrane with an ePTFE membrane in a middle and polyester membranes on two sides, and micropores with a bore diameter of 0.2 μm are defined evenly on the ePTFE membrane.

In an embodiment, in the S302, a duration of the first stage of the aerobic fermentation is in a range of 10 days to 13 days.

In an embodiment, in the S302, the moisture content of the mixed material after the first stage of the aerobic fermentation is 20% to 30%.

In an embodiment, a duration of the second stage of the aerobic fermentation is 8 days to 13 days, and the moisture content of the mixed material after the second stage of the aerobic fermentation is 20% to 30%.

Compared with the related art, the disclosure has no risk of secondary pollution, solves the problem of resource utilization of solid waste processors, and generates no waste residue, exhaust gas, or waste liquid.

In the S4, since a pH of the natural calcium-based bentonite is in a range of 6.5-7.2, and a pH of the fly ash is in a range of 8.5-9.8, and reducing the pH of the soil amendment is the first step in improving the acidity and alkalinity of the inferior soil. Increasing an amount of the natural calcium-based bentonite can meet the conditions. Generally, a ratio of the natural calcium-based bentonite and the fly ash is in a range of 2-3:1. Under the humic acid conditions provided by the weathered coal mentioned above, it can become an efficient soil amendment with a slightly acidic nature. A ratio of the natural calcium-based bentonite, the fly ash and the weathered coal is in a range of 2-3:1:1. After natural stacking the natural calcium-based bentonite, the fly ash and the weathered coal for 6 days to 7 days, the soil amendment is obtained, that is, a natural calcium-based bentonite synergistic coal-based solid waste amendment.

### Embodiment 2

A soil amendment for regulating salinity and alkalinity and solidifying heavy metals includes 50-70 parts by weight of natural calcium-based bentonite, 20-25 parts by weight of fly ash, 10-20 parts by weight of water, 20-25 parts by weight of weathered coal, and 2-6 parts by weight of composite microbial agent.

### Embodiment 3

A soil amendment for regulating salinity and alkalinity and solidifying heavy metals includes 50 parts by weight of natural calcium-based bentonite, 20 parts by weight of fly ash, 10 parts by weight of water, 20 parts by weight of weathered coal, and 2 parts by weight of composite microbial agent. The preparation method mentioned in the embodiment 1 is used to prepare the soil amendment for regulating salinity and alkalinity and solidifying heavy metals.

### Embodiment 4

A soil amendment for regulating salinity and alkalinity and solidifying heavy metals includes 70 parts by weight of natural calcium-based bentonite, 25 parts by weight of fly ash, 20 parts by weight of water, 25 parts by weight of weathered coal, and 6 parts by weight of composite microbial agent. The preparation method mentioned in the embodiment 1 is used to prepare the soil amendment for regulating salinity and alkalinity and solidifying heavy metals.

### Embodiment 5

A soil amendment for regulating salinity and alkalinity and solidifying heavy metals includes 60 parts by weight of natural calcium-based bentonite, 22.5 parts by weight of fly ash, 15 parts by weight of water, 22.5 parts by weight of weathered coal, and 4 parts by weight of composite microbial agent. The preparation method mentioned in the embodiment 1 is used to prepare the soil amendment for regulating salinity and alkalinity and solidifying heavy metals.

### Embodiment 6

The disclosure further provides an application method of the soil amendment for regulating the salinity and alkalinity and solidifying the heavy metals mentioned above in remediation of inferior soil with the natural calcium-based bentonite and coal-based solid waste.

From the above embodiments, it is evident that as poor-quality soils, both sandy soil and saline-alkali soil have their own drawbacks. The sandy soil has loose soil and large pore size, which result in very poor water and nutrient retention capabilities. Additionally, they have low organic matter content, making them quite infertile. In the case of saline-alkali soils, the primary issue is their high salinity and alkalinity, which can stress seed germination and plant growth. Physically, the saline-alkali soils are compact and prone to severe clumping, which is also detrimental to plant growth. Moreover, a scarcity of microbial communities and heavy metal pollution are common in many sandy and saline-alkali soils. Clearly, the disadvantages of poor-quality lands can be categorized into three interrelated yet distinct aspects: physical structure, chemical composition, and microbial composition. Therefore, when designing a soil amendment for poor-quality soils, it is necessary to address three aspects: optimizing soil physical structure, adjusting chemical composition, and enriching microbial communities. This is specifically manifested in regulating soil looseness, reducing soil alkalinity, solidifying soil inorganic salts and heavy metals, increasing organic matter content, and enriching the microbial community.

Since structure determines performance, and a single-component amendment cannot address this series of issues simultaneously. Therefore, formulating a combination of several amendments is an important method in the field. The combination not only leverages the strengths of each component but also the synergistic effects between the components can amplify these advantages. Based on the above facts, the disclosure selects natural calcium-based bentonite (PRT), fly ash (FMH), and weathered coal (FHM) as the basic materials for the combination and introduces agricultural and pastoral solid waste and biological microbial agent to prepare a series of inferior soil amendments through a mixed fermentation process. Specifically, for different types of poor-quality soils, the appropriate preparation process is selected by optimizing and adjusting the ratio of each component and the preparation conditions.

(1) The natural calcium-based bentonite is weakly acidic and possesses a certain capacity for adsorption, which allows it to adsorb salts and alkalis and increase the viscosity and water retention of the sandy soils. In addition, its porosity can provide a place for the attachment and proliferation of composite microorganisms (i.e., microbial agent). When combined with the fly ash and the weathered coal, the natural calcium-based bentonite more readily adsorbs the humic acid produced by weathered coal, leveraging the role of the microorganisms in treating salts, alkalis, and heavy metals.

(2) The fly ash possesses a certain capacity for adsorption, enabling it to adsorb the saline and alkaline substances found in the saline-alkali soils, which allows the composite microorganisms to consume these substances within the saline-alkali soils. The fly ash can also provide a surface for the attachment and proliferation of the composite microorganisms, thereby preventing the loss of the composite microorganisms. Additionally, the fly ash has a certain viscosity when mixed with water, which can bind the humic acid produced by the fermentation of the weathered coal, playing a stabilizing role and preventing nutrients from dispersing too quickly within the soil.

(3) The weathered coal, when mixed with the composite microorganisms, can serve as a culture medium that provides nutrients to the composite microorganisms. It also supplements the organic matter in the saline-alkali soils and other mixtures. Furthermore, when the weathered coal reacts with oxygen, it produces the humic acid, which can improve the salinity and pollution levels in the poor-quality soils. The organic matter in the weathered coal can also supply nutrients to the composite microorganisms, thus preventing them from becoming nutrient-deficient.

(4) The newly developed enhanced composite high-efficiency microorganisms can not only reduce the salinity and alkalinity of the saline-alkali soils and coal-based solid waste but also improve crop nutrient utilization. Additionally, they can effectively decrease the content of heavy metals in the saline-alkali soils, the sandy soils, contaminated soils, and the fly ash. The composite microorganisms such as Azotobacter sp., Aspergillus fungi, and Natronobacterium can consume the saline and alkaline substances in the poor-quality soils, thereby improving their salinity and alkalinity. Traditional soil amendments contain only single types of microorganism or no microorganism at all, and can only neutralize alkalinity or reduce salinity. The use of composite microorganisms can simultaneously reduce the salinity and alkalinity in the poor-quality soils. Moreover, the heavy metal solidifying microorganism can solidify heavy metals in fly ash, reducing their harm to poor-quality soils and crops.

In summary, by using the natural calcium-based bentonite, the fly ash, the weathered coal, and the composite microorganisms to enhance the effects of improving soil salinity and alkalinity and solidifying the heavy metals, and by using these substances in conjunction to improve the poor-quality soils, the amount of soil amendment used per acre is reduced compared to existing soil amendments. The microorganisms used are highly adaptable to extreme saline-alkali environments. The natural calcium-based bentonite and the fly ash, with their porous, homogeneous particle characteristics, and activated carbon-like properties, serve as excellent carriers for the composite microorganisms and soil conditioners for loosening the saline-alkali soils. The synergistic effect of natural calcium-based bentonite, the weathered coal, the fly ash, and the composite microorganisms (composite microbial agent) improves the physical and chemical properties of saline-alkali and contaminated soils, reduces pH and salt content, and enhances the soil's capacity for cultivation. The treated saline-alkali soil and sandy soil can be mixed together in a ratio of 1-2:2-2.5, combined with the efficient planting method of salt and drought-resistant plants (Elaeagnus angustifolia and Hippophae rhamnoides), which can green the desert, stabilize shifting sands, and facilitate ecological restoration.

In the above embodiments, the description of each embodiment has its own emphasis. For the parts that are not detailed or recorded in one embodiment, please refer to the relevant descriptions of other embodiments.

To further illustrate the relevant effects of the embodiments of the disclosure, the following experiments are conducted.

A greenhouse pot experiment with meadow grass is conducted, which research the impact of PRT-FMH-FHM on the properties of the saline-alkali soils, plant growth, and the migration and degradation of salts, alkalis, and pollutants in a soil-plant system. The results showed that PRT-FMH is more conducive to improving the buffering capacity of the saline-alkali soils and increasing their nutrient content. Compared with treatments using only FMH or FHM, the cation exchange capacity of the topsoil in the saline-alkali soils in a certain province treated with PRT-FMH-FHM increased by 11.4% and 10.2%, respectively. In a certain autonomous region, the cation exchange capacity of the topsoil in the saline-alkali soils and the soils contaminated with heavy metals increased by 10.4% and 8.5%, respectively. In another autonomous region, the cation exchange capacity of the topsoil increased by 12.3% and 14.0%, respectively. Total nitrogen contents in the three types of the saline-alkali soils increased by 10%-12%, 12%-13%, and 14%-16%, respectively.

(2) Additionally, the addition of PRT-FMH-FHM is more conducive to promoting plant growth. Compared with the treatment using only FMH, the biomass of meadow grass in the two types of poor-quality soils (i.e., sandy soil and heavy metal complex pollution in a certain autonomous region, and sandy soil in another autonomous region) treated with PRT-FMH-FHM increased by 10%-15%. Chlorophyll contents in meadow grass planted in the two types of poor-quality soils increased by 11%-13% and 9%-12%, respectively. The addition of PRT-FHM also significantly reduced the amount of heavy metal pollutants transferred from the soil system to the plants compared to the addition of only PRT (5%-9%). The accumulation of pollutants in meadow grass treated with PRT-FHM is 12%-17% lower than that in the corresponding treatments with only FHM. Therefore, PRT-FMH-FHM not only further improves soil properties but also, when mixed with the original soil in proportion, promotes the growth of plants (salt and drought-resistant plants, such as Elaeagnus angustifolia and Hippophae rhamnoides). It can also effectively limit the migration and degradation of pollutants in the plant system of poor-quality soils in the environment, reducing potential pollution risks.

Similarly, in a certain province, when PRT is mixed with FHM and FMH in the poor-quality soil at a ratio of 3:1:1, the aboveground biomass of meadow grass treated with PRT-FMH increases by 10%-12%, and the chlorophyll content increases by 8%-12%. In a certain autonomous region, after mixing PRT with FHM and FMH in the contaminated soil at a ratio of 3:1:1, the biomass of Hippophae rhamnoides increases by 11%-14%, and the biomass of Elaeagnus angustifolia increases by 8%-12%. The addition of PRT-FMH also significantly reduces the amount of salt and pollutants transferred from the poor-quality soil system to the plants compared to the addition of only FHM (by 5%-6%), and the accumulation of pollutants in Hippophae rhamnoides treated with PRT-FMH is 6%-9% lower than that in the corresponding treatment with only FHM.

Degradation effects of salt alkali and several special pollutants are shown in Table 1.

TABLE 1
Degradation effects of saline alkali and several special pollutants

| Saline alkali | PRT-FMH-FHM | Only FMH | Only FHM |
|---|---|---|---|
| situation | Degradation | Degradation | Degradation |
| and | rate | rate | rate |
| pollutants | (%) | (%) | (%) |
| Saline-alkali situation | 44.3-59.6 | 29.5-41.3 | 13.9-26.5 |
| Salicylic acid | 55.6-75.2 | 45.4-53.3 | 26.5-30.1 |
| Fungi and mycotoxins | 66.4-78.8 | 60.5-67.9 | 31.3-40.5 |
| Heavy metals | 69.9-81.5 | 52.8-69.1 | 24.3-39.2 |

The disclosure utilizes a range of agricultural and pastoral (straw and livestock manure) as well as coal-based (the fly ash, the weathered coal) solid wastes as raw materials, which helps avoid environmental pollution from these solid wastes. The product can remove heavy metals and organic pollutants from the soil, thus offering significant environmental benefits. The raw materials used are inexpensive and readily available, while the resulting product has a wide range of applications and a substantial demand. Additionally, the soil treated with the product of the disclosure significantly improves in quality, and the yield and quality of plants grown in it increase, therefore, the expected economic benefits after the transformation of this technological solution are enormous.

Addressing the issue that common soil amendments currently use sodium-based bentonite as a raw material, the disclosure employs natural calcium-based bentonite as a raw material. It pioneeringly combines the natural calcium-based bentonite, the fly ash, the weathered coal, agricultural and pastoral solid waste, and the composite microorganisms to leverage their respective strengths and amplify these advantages through the synergistic effects between the various raw materials. The disclosure fills some gaps in the domestic and international industry in terms of cost-effectiveness, resource utilization, environmental friendliness, technological innovation, and the expansion of application fields. On one hand, the disclosure uses agricultural and coal-based solid waste as raw materials, effectively resolving the environmental pollution caused by the above waste. On the other hand, as a soil amendment, natural calcium-based bentonite may help improve soil structure and nutrient conditions, enhance soil fertility and water retention capacity, thereby addressing soil quality issues in agricultural production.

Additionally, the raw materials used in the disclosure are inexpensive and easily accessible, and the process is simple and easy to operate, with minimal equipment requirements. This overcomes the technological bias regarding cost and resource aspects. Environment-friendly technological solutions are increasingly popular in today's society. By using environment-friendly materials such as agricultural and pastoral solid waste, coal-based solid waste, and natural calcium-based bentonite as raw materials, and by producing a product that can remove heavy metals and other organic pollutants from the soil, the disclosure overcomes the environmental technological bias. Some industries may be conservative about new materials or technologies. The use of materials like natural calcium-based bentonite for technological innovation can break through traditional biases, promote technological advancement, and overcome the innovation-level technological bias.

The above description is only preferred specific embodiments of the disclosure, but the scope of protection of the disclosure is not limited to this. Any modifications, equivalent substitutions, and improvements made by those skilled in the art familiar with the technical field within the scope of the disclosure within the spirit and principles of the disclosure should be included in the scope of protection of the disclosure.

What is claimed is:

1. A soil amendment for regulating salinity and alkalinity and solidifying heavy metals, comprising:
50-70 parts by weight of calcium-based bentonite, 20-25 parts by weight of fly ash, 10-20 parts by weight of water, 20-25 parts by weight of weathered coal, and 2-6 parts by weight of composite microbial agent.

2. A preparation method, wherein the preparation method is used to prepare the soil amendment for regulating salinity and alkalinity and solidifying heavy metals as claimed in claim 1, and the preparation method comprises:
S1: modifying the calcium-based bentonite;
S2: preparing a composite microbial agent;
S3: preparing humic acid from the weathered coal; and
S4: preparing the soil amendment for regulating salinity and alkalinity and solidifying heavy metals.

3. The preparation method as claimed in claim 2, wherein, in the S1, the modifying the calcium-based bentonite comprises:
dissolving auxiliary materials in the water, then evenly spraying the water dissolved with the auxiliary materials onto a surface of the calcium-based bentonite, wherein a water content of the calcium-based bentonite is in a range of 20%-30%; and raw materials, by mass, comprise: 40%-60% of the calcium-based bentonite, and 10%-15% of food waste, distiller's grains, and straw powder, and the auxiliary materials, by mass, comprise: 1%-2% of urea, and 1%-3% of calcium chloride; and
adding heavy metal solidifying bacteria Bacillus asahii with an addictive amount of 0.1%-0.3% to solidify residual heavy metals in the calcium-based bentonite.

4. The preparation method as claimed in claim 2, wherein, in the S2, the preparing a composite microbial agent comprises:
mixing Azotobacter sp., Pseudomonas chlororaphis strain R5, Bacillus subtilis, and Pseudomonas putida strain Rs-198 with a mixing ratio in a range of 1-2:2-2.5:2-2.5:3-5.

5. The preparation method as claimed in claim 2, wherein, in the S3, the preparing humic acid from the weathered coal comprises:
S301: mixing the weathered coal, food waste, livestock and poultry manure, and straw powder with the composite microbial agent to obtained a mixed material, thereby performing aerobic fermentation on the mixed material for humification in a fermentation tank by using a film-covered method, wherein humidity of the mixed material is in a range of 15% to 20%, a stacking height of the mixed material is in a range of 100 centimeters (cm) to 120 cm, and an aeration rate is in a range of 2 cubic meters per second (m³/s) to 6 m³/s, and a duration of the aerobic fermentation is in a range of 10 days to 20 days; dehydrating the mixed material to 20% to 22%, and followed by crushing and sieving with a 1 millimeter (mm) sieve to prepare a saline-alkali planting improved substrate;
S302: piling the mixed material into the fermentation tank, and performing a first stage of the aerobic fermentation on the mixed material under positive pressure with a film cover to obtain a mixed material after the first stage of the aerobic fermentation; wherein a duration of the first stage of the aerobic fermentation is in a range of 10 days to 13 days, and a moisture content of the mixed material after the first stage of the aerobic fermentation is 20% to 30%;
S303: uncovering and turning the mixed material after the first stage of the aerobic fermentation to obtain an uncovered and turned mixed material;
S304: performing a second stage of the aerobic fermentation without film coverage on the uncovered and turned mixed material to obtain a fermented mixed material, wherein the second stage of the aerobic fermentation is performed in a ventilated workshop with a roof, a loader is used to transport the mixed material to the ventilated workshop, and the mixed material is turned during transport;
S305: after completing the aerobic fermentation to obtain the humic acid, using a part of the fermented mixed material as a return material for the mixing in the S301.

6. The preparation method as claimed in claim 5, wherein, in the S302, after piling the mixed material into the fermentation tank, the stacking height of the mixed material is higher than a height of the fermentation tank, and the stacking height of the mixed material is in a range of 100 cm to 120 cm;
wherein a bottom of the fermentation tank defines three air supply channels, and a 2.2 kilowatts (kW) fan is used for ventilation for 8 hours to 9 hours per day; the film cover is punched with holes, temperature sensors are disposed on the holes to monitor fermentation temperature in real-time, and a number of the temperature sensors is equal to a number of days in the first stage of the aerobic fermentation; and the film cover is fixed with weights during a film-covering process of the first stage of the aerobic fermentation.

7. The preparation method as claimed in claim 5, wherein, in the S302, the film cover is a composite membrane with an expanded polytetrafluoroethylene (ePTFE) membrane in a middle and polyester membranes on two sides; and micropores with a bore diameter of 0.2 microns (μm) are defined evenly on the ePTFE membrane.

8. The preparation method as claimed in claim 5, wherein, in the S304, a duration of the second stage of the aerobic fermentation is in a range of 8 days to 13 days, and the moisture content of the mixed material after the first stage of the aerobic fermentation is in a range of 20% to 30%.

9. The preparation method as claimed in claim 2, wherein, in the S4, the preparing the soil amendment for regulating salinity and alkalinity and solidifying heavy metals comprises:
stacking the calcium-based bentonite, the fly ash, the humic acid, and the weathered coal naturally for 6 days to 7 days to obtain the soil amendment for regulating salinity and alkalinity and solidifying heavy metals; wherein a pH of the calcium-based bentonite is in a range of 6.5 to 7.2, a pH of the fly ash is in a range of 8.5 to 9.8, a ratio of the calcium-based bentonite and the fly ash is in a range of 2-3:1, and a ratio of the calcium-based bentonite:the fly ash:the weathered coal is in a range of 2-3:1:1.

10. An application method of the soil amendment for regulating salinity and alkalinity and solidifying heavy metals in remediation of inferior soil with the calcium-based bentonite and coal-based solid waste, comprising:
remediating the inferior soil by using the soil amendment for regulating salinity and alkalinity and solidifying heavy metals as claimed in claim 1.
